(19) United States
(12) Patent Application Publication
(10) Pub. No.: US 2007/0040313 A1
(43) Pub. Date: Feb. 22, 2007

(54) Rotational grip mechanism for flat and curved panels

(76) Inventor: James Andrew Butler, Gallatin, TN (US)

Correspondence Address: JONES, TULLAR & COOPER, P.C., P.O. BOX 2266 EADS STATION, ARLINGTON, VA, 22202, US

(21) Appl. No.: 11/505,500

(22) Filed: Aug. 17, 2006

Related U.S. Application Data
(60) Provisional application No. 60/708,797, filed on Aug. 17, 2005.

(51) Int. Cl. B25B 1/20

(52) U.S. Cl. 269/43

(57) ABSTRACT

There is provided a mechanism for gripping and retaining flat or curved panels or the like in a generally planar arrangement. More specifically, there is provided a clamping cartridge which includes a plurality of rotatable pin pairs which operate to engage the edges of the panels and apply a clamping force thereto. Preferably, the rotatable pin pairs are resiliently rotatable so that the clamping force which can be applied to the panel edge may be varied. The resilient rotation of the pin pairs may be effected through the use of a spring or other resilient member on which an actuator is operable for ultimately rotating the pin pairs. The pins of each pin pair, which are normally aligned generally perpendicularly to the edge of the panel when in their open-most panel receiving and releasing position, are rotatable into engagement with the edge of the panel so as to clamp the edge therebetween. Further operation of the actuator causes the clamping force to vary the clamping force on account of the spring member without imparting further rotation. The resilient rotation of the pin pairs permits panels of varying thickness and/or multiple panels to be clamped by the same cartridge and permits operability of the device when not all of the pin pairs are used to retain a panel. The clamping force increases with thickness of panel(s) due to increased compression of spring member. One or more such clamping cartridges can be used in a variety of storage and/or packaging systems.

### CROSS-REFERENCE TO RELATED APPLICATIONS

This application claims priority on U.S. Provisional Application No. 60/708,797 filed Aug. 17, 2005.

### FIELD OF THE INVENTION

The present invention relates to a clamping apparatus for holding and positioning a plurality of items and, more particularly, a clamping cartridge for releasably clamping a plurality of planar objects as well as moderately curved ones.

### BACKGROUND OF THE INVENTION

There are numerous instances where a series of flat and/or moderately curved sheet or panel-type products need be transported and/or stored. When all such items are identical, there is usually no need to be concerned over loading and unloading sequences. However, when the items are not identical, any sequenced access must be predetermined which usually entails predetermined loading strategies and, furthermore, random access may simply not be possible. Moreover, where the items vary in thickness, group clamping typically requires individual (i.e. time-consuming) adjustment of respective clamping mechanisms. Typically, these panels are to be transported, stored or otherwise handled by using only a limited, allowable edge area around the panels.

Existing solutions are either cumbersome, inefficient and/or unable to address all of the user-defined requirements. These requirements and the challenges were, mainly, the following: the ability to load a variety of flat and/or moderately curved panel sizes and multiple thicknesses within a given packaging unit, for example in a custom metal rack; the ability to access, remove or replace any one or all panels individually, without affecting the rest of the panels; the ability to grip and hold the parts (panels) during transport and storage; adjustable grip force; user-friendly operating sequences; reliability and ease of maintenance; and cost effectiveness.

### SUMMARY OF THE INVENTION

There is provided a mechanism for gripping and retaining flat or curved panels or the like in a generally planar arrangement. More specifically, there is provided a clamping cartridge which includes a plurality of rotatable pin pairs which operate to engage the edges of the panels and apply a clamping force thereto. Preferably, the rotatable pin pairs are resiliently rotatable so that the clamping force which can be applied to the panel edge may be varied. The resilient rotation of the pin pairs may be effected through the use of a spring or other resilient member on which an actuator is operable for ultimately rotating the pin pairs. The pins of each pin pair, which are normally aligned generally perpendicularly to the edge of the panel when in their open-most panel receiving and releasing position, are rotatable into engagement with the edge of the panel so as to clamp the edge therebetween. Further operation of the actuator causes the clamping force to vary the clamping force on account of the spring member without imparting further rotation.

The resilient rotation of the pin pairs permits panels of varying thickness and/or multiple panels to be clamped by the same cartridge and permits operability of the device when not all of the pin pairs are used to retain a panel. The clamping force increases with thickness of panel(s) due to increased compression of spring member.

One or more such clamping cartridges can be used in a variety of storage and/or packaging systems. The cartridges can be used in a variety of containers like hard (plastic) bins, totes, wooden and even paper (cardboard) structures, as well as on carts, cars, dollies, elevators, conveyors, or in fixed applications (on walls, on floors, on structures of any kind). In a packaging system having at least two such cartridges, corresponding pin pairs of the respective cartridges are aligned in the same plane.

Other features and advantages of the invention will become apparent from the following description and drawings.

### BRIEF DESCRIPTION OF THE DRAWINGS

FIG. 1 is a perspective view of one embodiment of a single cartridge according to the invention in its “open” position ready to receive panels between corresponding pin pairs of each twist wheel;

FIG. 2 shows a plan (top) view of the cartridge of FIG. 1, broken apart centrally to indicate variable length according to the specific application;

FIG. 3 is a side elevation of the cartridge of FIG. 2;

FIG. 4 is a bottom view of the cartridge of FIG. 2, broken away on one side to reveal internal details;

FIG. 5 is an end view of the cartridge of FIG. 2;

FIG. 6 is the opposite end view of the cartridge of FIG. 2;

FIG. 6A is a magnified view of FIG. 6, rotated in an end view elevation, showing details thereof;

FIG. 7A is a perspective view of one of the wheel members as employed in the first embodiment; FIG. 7B is an elevational view thereof;

FIG. 8A is a perspective view of one of the spring members; FIG. 8B is an elevational view thereof;

FIGS. 9 and 10 show a broken away partial perspective view of the bottom of the cartridge illustrating the inner workings of the cartridge during operation;

FIGS. 11 and 12 show a partial top perspective view of the cartridge in operation, wherein FIGS. 11 and 12 correspond with the operational states shown in FIGS. 9 and 10, respectively;

FIGS. 13A-13D are schematics illustrating the principles of operation of the invention;

FIG. 14A is a perspective view of a self-contained rotational gripping unit for use in a second embodiment of the invention. FIG. 14B is a perspective view of the gripping unit of FIG. 14A rotated by 90 degrees;

FIGS. 15A, 15B and 15C are side elevational, plan and bottom views, respectively, of the gripping unit. FIG. 15D is a cross-sectional view of the gripping unit as seen along lines D-D of FIG. 15A;

FIG. 16 is a plan view of a clamping cartridge according to the second embodiment of the invention, shown without an actuator, and broken apart centrally to indicate variable length;

FIG. 17 is a side elevational view of the clamping cartridge of FIG. 16;

FIG. 18 is a bottom view of the clamping cartridge of FIG. 16 partially broken-away to show details thereof;

FIG. 18A is a enlarged bottom view detail of the end section of the clamping cartridge as shown in FIG. 18;

FIG. 19 is a end view of the cartridge of FIG. 16; and

FIG. 20 is a perspective view of a transportation/storage rack illustrating a use of the clamping cartridges according to the invention.

### DESCRIPTION OF THE INVENTION

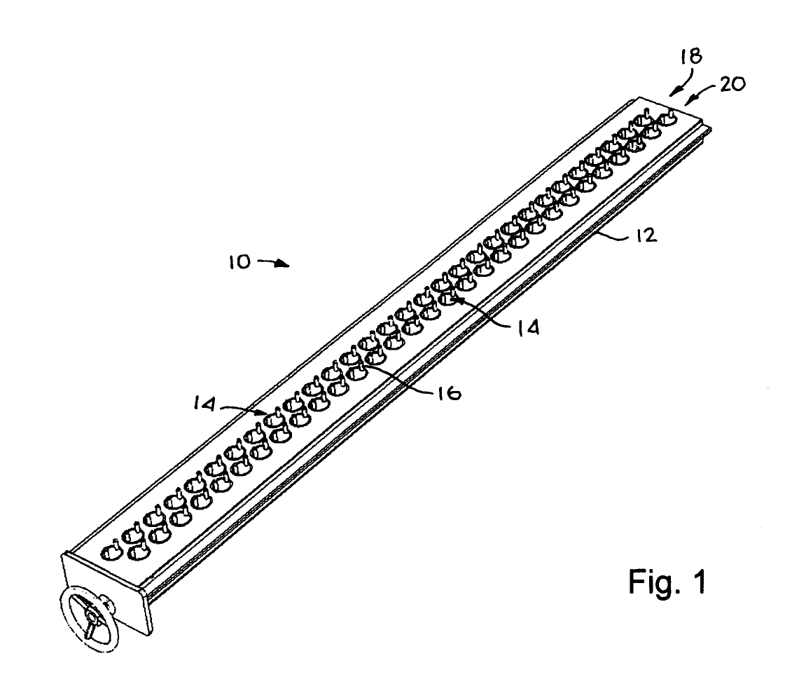

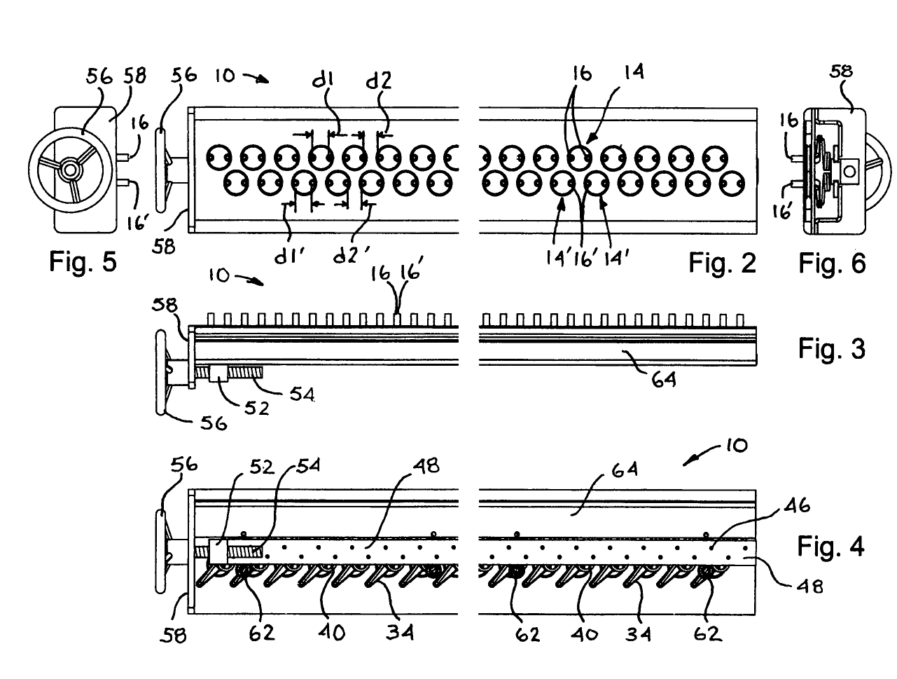

Referring to FIGS. 1 to 6, a clamping cartridge 10 is shown comprising an elongate chassis 12 in which there is disposed a plurality of rotatable pairs 14 of fingers or pins 16. The pins 16 of each pin pair 14 are aligned generally perpendicularly to the edge of the panel to be clamped when in their open-most panel-receiving/releasing position, which alignment will generally be in the longitudinal direction of the cartridge 10. The pin pairs 14 are disposed in one or more rows 18,20 along the length of the cartridge chassis 12. The pins 16 of each pin pair 14 are spaced apart a predetermined distance d1 which is slightly greater than the maximum expected thickness of the edge of the glass pane or other panel-like article (not shown) to be clamped. For compactness and operational efficiency (as will be explained in greater detail hereinbelow), there are preferably two rows 18,20 of pin pairs 14, with one row 20 being longitudinally offset with respect to the other row 18, so that the pins 16 of a pin pair 14 in the first row 18 are generally transversely aligned with adjacent pins 16′ of adjacent pin pairs 14′, as shown in FIGS. 2 and 3. While preferably the spacings d1,d1′ between pin pairs 14,14′ in each row 18,20 are equal as shown in the drawings (resulting in equal spacings d2,d2′ between pins of adjacent pin pairs), it will be appreciated that the spacing d1 of the pin pair 14 in one row 18 may be different from the spacing d1′ of the pin pair 14′ in the other row 20, while still maintaining transverse alignment of the pins 16. Alternately, the spacings d1,d1′ can vary between pin pairs 14,14′ in each row 18, 20, while still maintaining transverse alignment of the pins 16 when the clamping cartridge 10 is in its open/releasing position. Such arrangements may be beneficial where panels of predetermined variable thicknesses are desired to be clamped. However, given the ability of the equi-spaced embodiment shown in the drawings to accommodate varying thicknesses of panels within the same cartridge, any benefits to be derived from a variably-spaced embodiment in compactness efficiency may not outweigh the disadvantages of part-dissimilarity and complexity of assembly and operation.

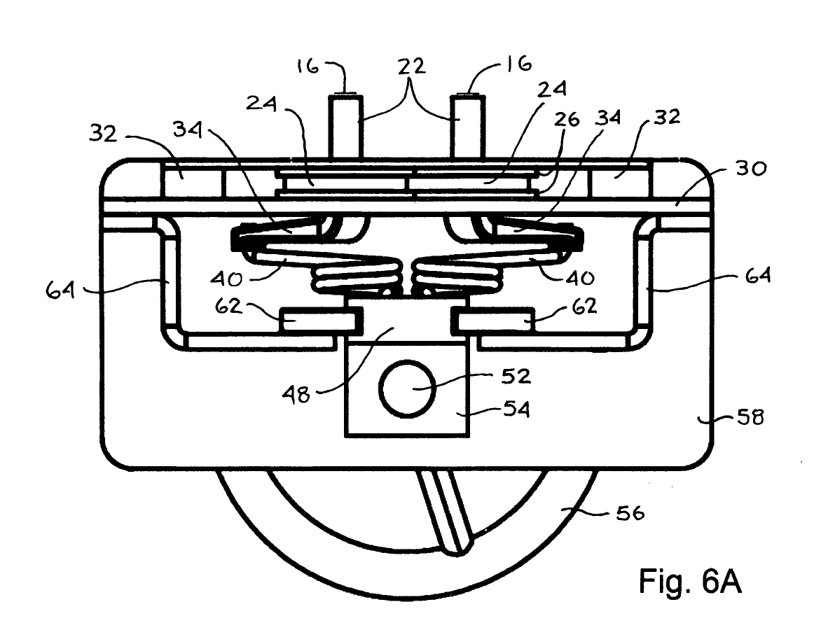

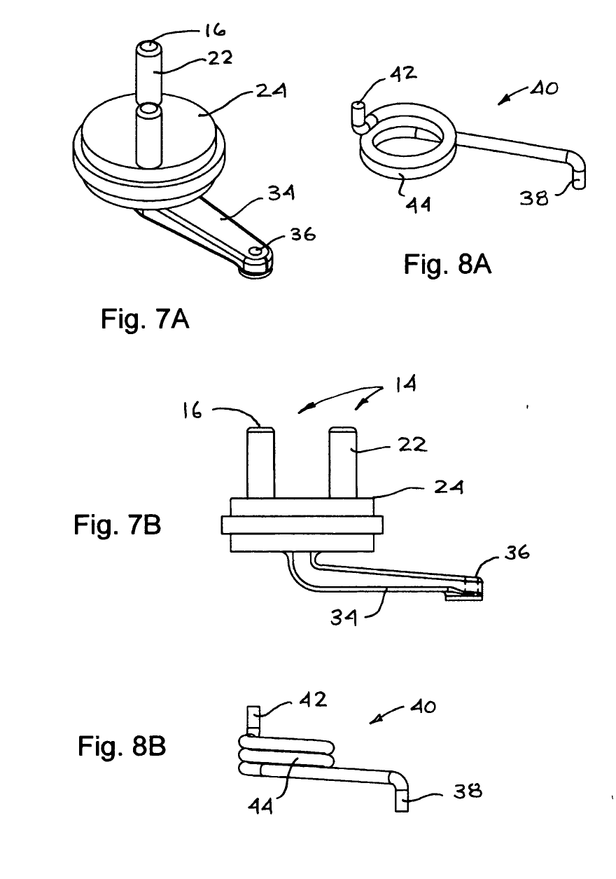

The pins 16 of each pin pair 14 are preferable provided on a rotatable support or wheel 24 which is best shown in FIGS. 7A and 7B. The pins 16 may have a protective resilient sleeve 22 made for example of rubber or urethane to reduce the potential for damage to the panel edge during clamping. The wheels 24 are seated or journalled in bearing rings 26 disposed in sockets in upper and lower support plates 28,30 as best shown in FIG. 6A, so that the pins 16 project outwardly of the upper plate 28. Bars 32 connect and align the upper and lower support plates 28,30 and assist in maintaining proper spacing so that wheels 24 are freely rotatable yet braced against other movement within the socket. The wheels 24 are provided with actuator arms 34 (see FIGS. 7A and 7B) which extend through the lower plate 30 and which are used for rotating the wheels 24. The arms 34 have a hole 36 adapted to receive one end 38 of a spring member 40, which spring member 40 is shown best in FIGS. 8A and 8B. The other end 42 of each spring member 40 is affixed to a respective hole 46 in a translatable plate 48. Translatable plate 48 is attached to a threaded block 52. A threaded shaft 54 which extends from a handwheel 56 through the end crank plate 58 is engaged within the threaded block 52. When the handwheel 56 is rotated, the threaded shaft 54 rotates, causing the threaded block 52 and the translatable plate 48 attached thereto to translate. Bearings 62, which are supported by bearing rails 64 attached to the lower plate 30, engage in races in translatable plate 48 for smooth linear movement thereof. While a simple rotation-to-translation actuation means has been shown, it will be appreciated that the translatable plate may be linearly movable by any mechanical, electrical or electromechanical actuation means.

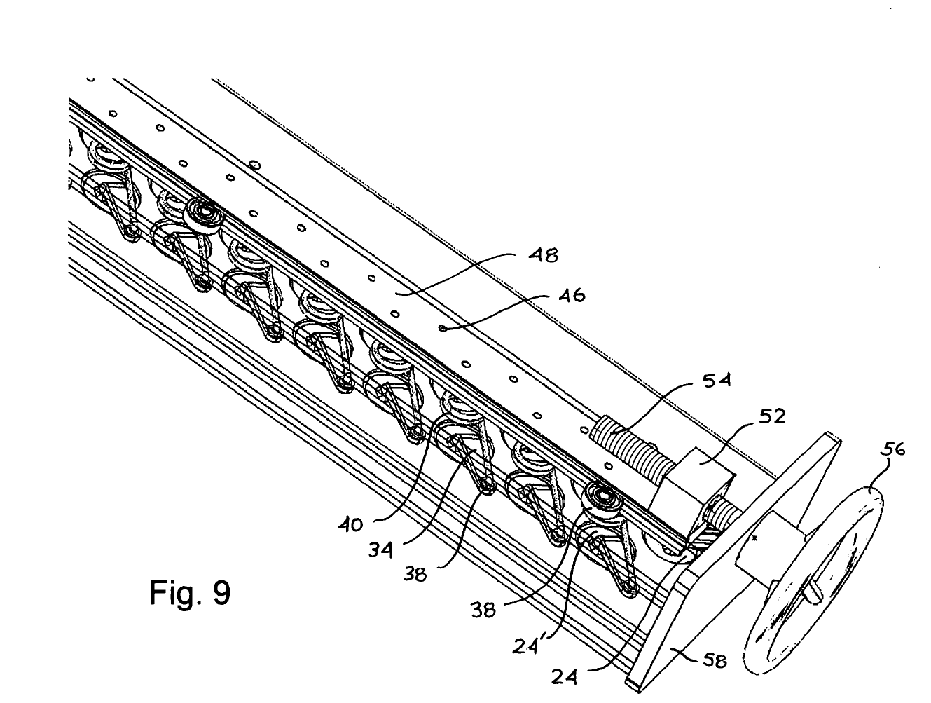

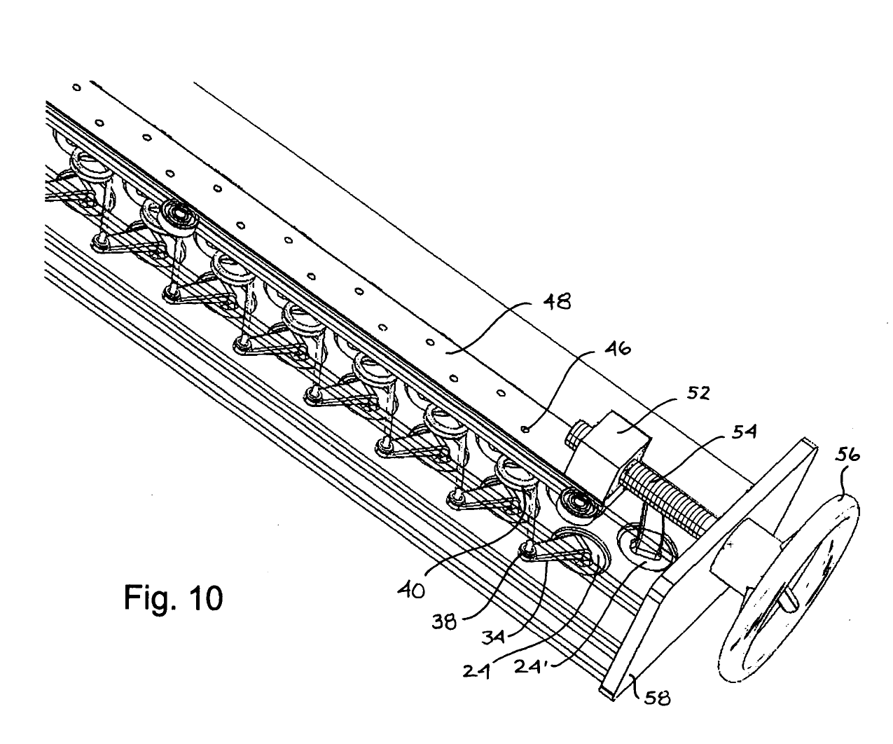

In operation, looking at FIGS. 9 and 10, when the hand wheel 56 is rotated, the threaded shaft 54 attached thereto interacts with thread block 52 to cause the translatable plate 48 attached thereto to moving linearly. Bearings 62 smoothly guide movement of translatable plate 48. The spring members 40, which have one end 42 inserted in the holes 46 in translatable plate 48 and the other end 38 attached to arm 34 of wheel 24, cause the wheels 24 to rotate, with wheels 24′ rotating oppositely to wheels 24. The spring member 40 may have a coiled portion 44 to provide for greater resiliency and greater spring force range over the range of translation of the translatable plate 48.

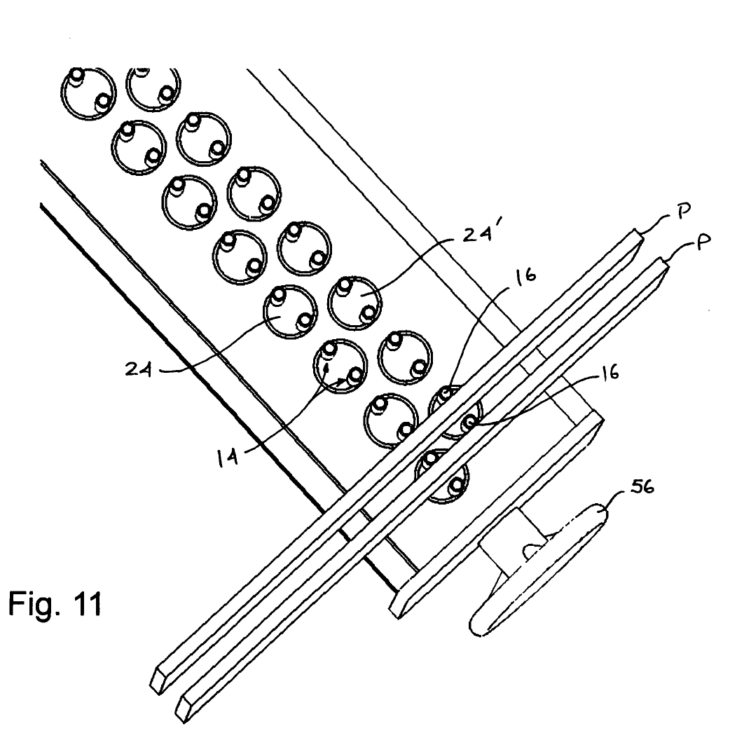

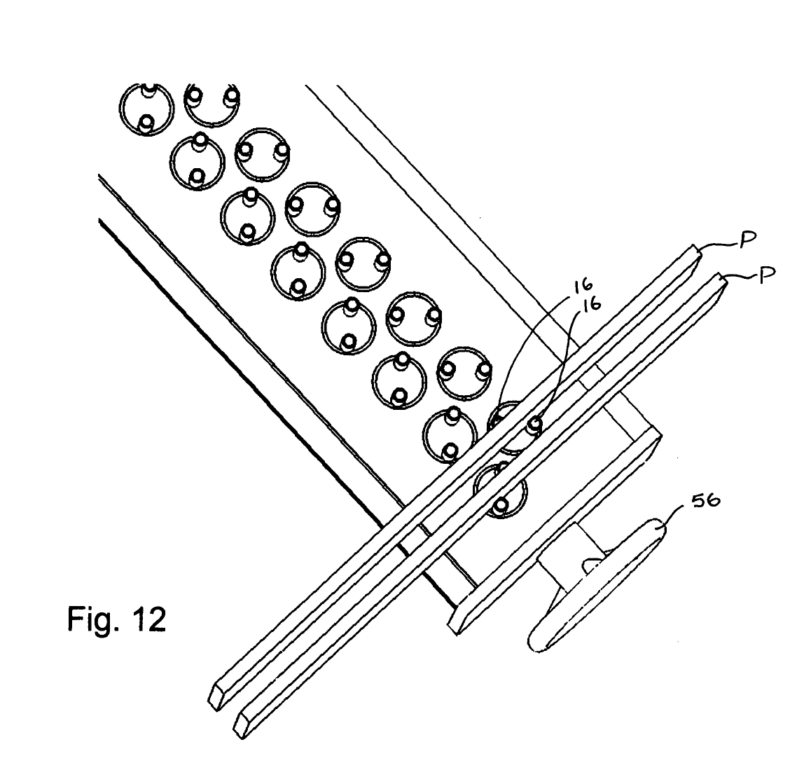

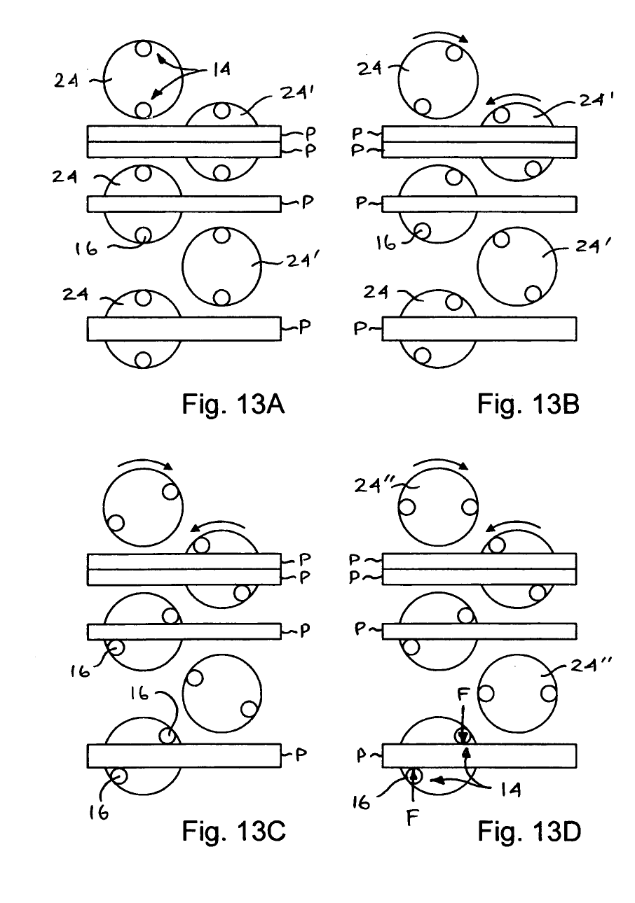

Turning to FIGS. 11-12 and schematic FIGS. 13A-13D, the wheels 24,24′ are in their “open” or panel receiving position in FIGS. 11 and 13A with the pin pairs 14 aligned generally transverse to the planes of the panels P. One or more panels P up to the thickness of the distance between pin pairs 14 of each wheel 24,24′ can be inserted between its pin pair 14. As the hand wheel 56 is rotated, the translatable plate 48 (not shown) translates linearly as explained above, causing the rotation of the wheels 24,24′ (see FIG. 13B) as explained above. When the pins 16 encounter the edges of the panel P, the wheel 24,24′ will effectively stop rotating (see FIG. 12 and 13C). Continued rotation of the hand wheel 56 will continue to translate plate 48, which due to the presence of spring members 40, will cause a greater rotational force to be applied to the wheels 24,24′, thereby causing a greater grasping force F to occur to the edge of the panel P between the pin pairs 14 (see FIG. 13D). Those wheels 24″ wherein no panel(s) P is/are inserted therebetween, will continue to rotate to a “closed” position (shown in FIG. 13D) which may be wherein the pin pairs 14 are generally parallel to the panel direction or which may be dictated by way of a physical stop for the translatable plate 48 and/or the hand wheel 56. Obviously, the pin pairs need not be rotated more than 90 degrees. By providing a stop to limit the plate's translation, the maximum force applicable to any panel/panels gripped between pin pairs can be limited. A locking mechanism (not shown) is provided to enable the translatable plate 48 to be releasably locked in any position over its entire range of motion.

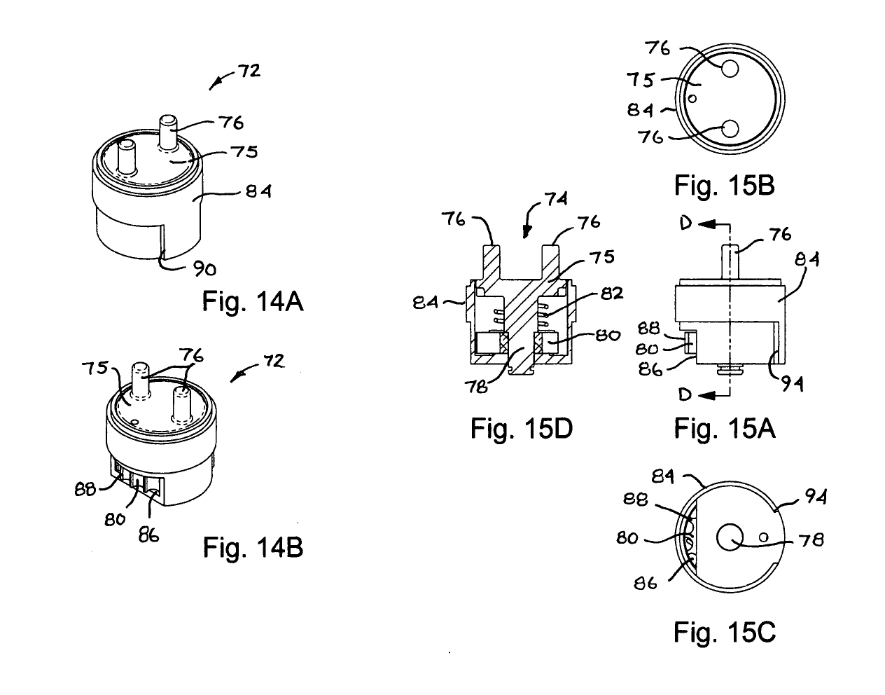

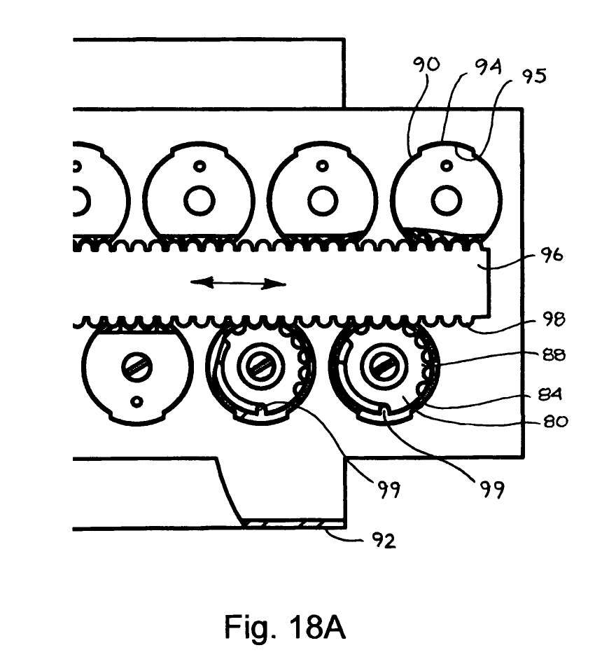

In a second embodiment of the invention, shown in FIGS. 14A-19, there is provided a clamping cartridge 70, which is similar to cartridge 10 in its principles of operation, but whose construction differs in that the actuator “arm”, spring and clamping device (pin pair) are assembled into a self-contained unit 72 that can be easily installed/removed to facilitate assembly and maintenance. The gripping unit 72, which is shown in detail in FIGS. 14A-15D, has a wheel assembly 74 from which a pair of pins 76 project from a wheel portion 75. The wheel assembly 74 includes a spindle 78 on which there is provided an actuator gear 80. A coil spring 82 is disposed concentrically about the spindle 78 and has one end affixed to the gear 80 and the other end attached to the wheel portion 75. The wheel assembly 74, spring 82 and gear 80 assembly is rotatably mounted in a housing or cup 84. The cup 84 has an aperture 86 through which a toothed section 88 of the gear 80 projects. The cups 84 are designed to fit securely but removably within sockets 90 provided in a cartridge chassis 92 (see FIG. 19). To facilitate alignment and registration of the cups 84 within sockets 90 and to prevent rotation thereof during clamping, a shoulder 94 may be provided on the cup 84 which is engageable with a corresponding recess 95 (see FIG. 18A) in the socket 90.

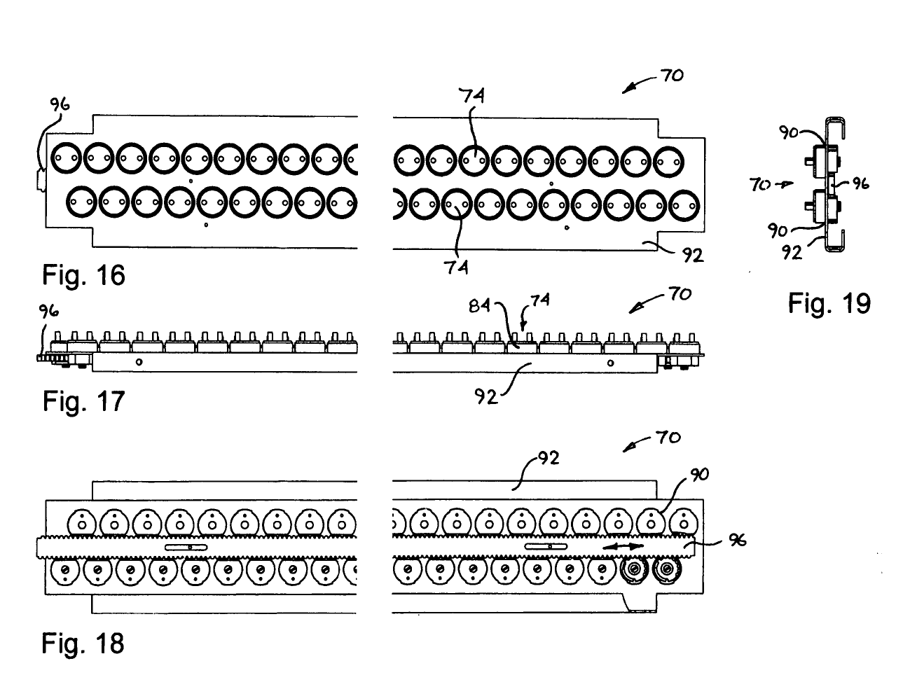

Referring to FIGS. 16 to 19, a cartridge 70 is shown wherein a plurality of gripping units 72 are disposed in respective sockets 90 in a chassis 92 such that the toothed sections 88 of the gears 80 projecting from the apertures 86 in the cups 84 in each row of gripping units are in general alignment. A slider 96, having teeth 98 which are designed to mesh with the toothed sections 88 of gears 80, is slidably mounted relative to the chassis 92 so as to engage the toothed sections 88 of gears 80, as shown best in FIGS. 18 and 18A. Translational movement of the slider 96 by way of any form of conventional actuation means (not shown) rotatably drives the gears 80, springs 82 and wheel assemblies 77, resulting in rotation of pin pairs 76 in the same manner that translation of the plate 48 results in rotation of the pin pairs 14 of the cartridge 10.

In operation, the cartridge 70 functions substantially the same as cartridge 10 as explained above in connection with FIGS. 11-12 and schematic FIGS. 13A-13D. When a panel is disposed between the pins 76 of a gripping unit 72 and the slider 96 is caused to translate, the pin pair 76 rotates until the pins 76 engage the edge of the panel (not shown). Continued translation of the slider 76 forces further rotation of the gears 80, compressing springs 82 and thereby generating a gripping force relative to the amount of spring compression. Stops 99 may be provided within cups 84 to limit the rotation of gears 80 and, hence, the maximum clamping force. Alternately, stops may be provided in connection with slider 96 (not shown) or in association with the actuation means (also not shown) for the slider 96.

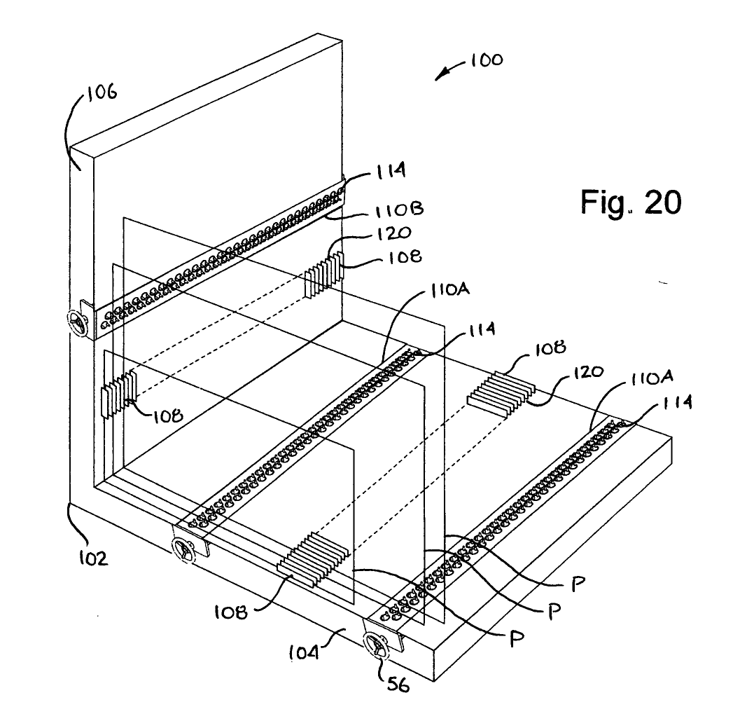

The clamping cartridges 10,70 can be used in a variety of storage and/or packaging systems. The cartridges 10,70 can be used in a variety of containers like hard (plastic) bins, totes, wooden and even paper (cardboard) structures, as well as on carts, cars, dollies, elevators, conveyors, or in fixed applications (on walls, on floors, on structures of any kind). In one such application shown in FIG. 20, a glass-panel storage rack 100 is realized comprising a frame 102 having a generally horizontal bottom support 104 and a generally vertical side support 106 are attached. At least one clamping cartridge is preferably provided in association with each support 104,106 such that the clamping pin pairs 114 of the horizontal support cartridge(s) 110A align in the same plane with the corresponding clamping pin pairs 114 of the vertical support cartridge(s) 110B. The clamping cartridges 110A,110B when in their open position as aforesaid are adapted to receive the edges of glass panels P to be positioned between corresponding pin pairs 114. The clamping cartridges 110A,110B can then be closed as aforesaid so as to clampingly retain the glass panels P within the rack 100.

When any one of the glass panels P is to be removed, the clamping cartridges 110A,110B are opened and the panels P can be removed as desired. Although when the clamping cartridges 110A,110B are opened, the edges of glass panels P are still bounded by the pin pairs 114 and thus the panels P should remain in place until removed. However, it may be desirable to incline the rack 100 to take advantage of gravity to ensure the panels P stay in the rack 100 when the clamping cartridges 110A,110B are opened.

The rack 100 may also include separate seating/supporting devices 108 which can aid in panel placement and support, particularly when the clamping cartridge is in an open loading or unloading position. As shown, the seat/supports 108, which are attachable to convenient locations on the bottom and/or side supports 104,106, have a multiple U-shaped cross-section so as to provide a plurality of parallel channels 120 which are aligned with the pin pairs 114 of the clamping cartridges. The seat/supports may also be built directly onto the cartridge. The seat/supports 108 can be made of any appropriate material bearing in mind the articles expected to be transported or stored in the rack 100. As shown, the seat/supports 108 are made from an extruded plastics material.

Depending on the arrangement of clamping cartridges and seat/supports 108 in a given rack 100, it may be possible to use the rack 100 to store or transport not only a plurality of identical articles, but also differing articles. As can be seen in FIG. 20, different sizes of glass panels P are retained in the rack 100 although not all of the clamping cartridges are used for every panel. Since the clamping cartridges 110A,110B function in the same general manner, their use in a rack 100 would be the same as explained above with clamping cartridge 10.

Depending on the number of clamping cartridges employed in any one rack and their accessibility, it may be advantageous to provide a linkage mechanism (not shown) to operate them simultaneously or to utilize power-driven shafts with an associated control unit (not shown) to selectively rotate the shafts individually or simultaneously.

The rack 100 may be arranged in such a manner that the cartridges 110A,110B may be removable from rack 100 and replaceable with cartridges of a different capacity (i.e. pin pair pin spacing or with other different properties (i.e. gripping strength, pin length, etc.), to suit the task at hand.

While there has been shown and described herein a clamping cartridge for panel-type products and a rack for its application, it will be appreciated that various modifications and or substitutions may be made thereto without departing from the spirit and scope of the invention.

I claim:

1. A clamping cartridge for clamping a plurality of panel-like articles comprising:
a plurality of rotatable pin pairs, said pins of each said pin pair being spaced apart for receiving an edge portion of a panel-like article therebetween;
rotating means for rotating each of said plurality of pin pairs;
whereby rotation of said pin pairs causes said pins of each pair to engage opposed sides of said edge so as to apply a clamping force thereto.

2. The clamping cartridge of claim 1, wherein said rotating means resiliently rotates said pin pairs into engagement with said edge portion of said panel-like article.

3. The clamping cartridge of claim 2, wherein said rotating means rotates said pin pairs in unison.

4. The clamping cartridge of claim 3, wherein said rotating means comprises a spring member disposed between each pin pair and an actuation means operable on said spring members for resiliently rotating said pin pairs.

5. The clamping cartridge of claim 4, wherein:
said actuation means comprises:
a slidable plate to which said spring members are attached; and
translation means for translating said slidable plate.

6. The clamping cartridge of claim 4, wherein:
said pins are disposed on a rotatable wheel to which said spring member is connected.

7. The clamping cartridge of claim 4, wherein said actuation means comprises:
a gear member to which each said spring member is concentrically attached;
and driving means for rotatably driving said gear members.

8. The clamping cartridge of claim 7, wherein said driving means comprises:
a slidable plate having toothed edges which are adapted to mesh with said gear members; and
translation means for translating said slidable plate.

9. The clamping cartridge of claim 8, wherein said pins are disposed on a rotatable wheel to which said spring member is connected.

10. The clamping cartridge of claim 3, wherein the pin pairs are provided in at least one row.

11. The clamping cartridge of claim 3, wherein the pin pairs are provided in a pair of rows.

12. The clamping cartridge of claim 3, wherein the pin pairs are provided in first and second rows, said rows being staggered such that the pins of the pairs on the first row are transversely aligned with the opposite pins of the pairs in the second row, when said pin pairs are in an open-most panel receiving and releasing position.

13. A transportation or shipping package comprising one or more clamping cartridges as claimed in claim 1 used for clamping, spacing, separating and/or supporting one or more panel-type articles to be contained therein.

14. A transportation or shipping package according to claim 13, comprising at least two clamping cartridges, wherein corresponding pin pairs of the cartridges are aligned in the same plane.

15. A clamping cartridge for clamping one or more panel-like articles comprising:
a plurality of rotatable pin pairs, said pins of each said pin pair being spaced apart for receiving an edge portion of a panel-like article therebetween;
rotating means for applying a resilient rotational force to said pin pairs in unison, whereby rotation of said pin pairs causes said pins of each pair to engage opposed sides of said edge so as to apply a variable clamping force thereto.

16. The clamping cartridge of claim 15, wherein said rotating means comprises a spring member disposed between each pin pair and an actuation means operable on said spring members for resiliently rotating said pin pairs.

17. The clamping cartridge of claim 16, wherein said actuation means comprises:
a slidable plate to which said spring members are attached; and
translation means for translating said slidable plate.

18. The clamping cartridge of claim 16, wherein said actuation means comprises:
a gear member to which each said spring member is concentrically attached;
and driving means for rotatably driving said gear members.

19. The clamping cartridge of claim 18, wherein said driving means comprises:
a slidable plate having toothed edges which are adapted to mesh with said gear members; and
translation means for translating said slidable plate.

20. The clamping cartridge of claim 15, wherein the pin pairs are provided in first and second rows, said rows being staggered such that the pins of the pairs on the first row are transversely aligned with the opposite pins of the pairs in the second row, when said pin pairs are in an open-most panel receiving and releasing position.

21. A transportation or shipping package comprising one or more clamping cartridges as claimed in claim 15 used for clamping, spacing, separating and/or supporting one or more panel-type articles to be contained therein.

22. A transportation or shipping package according to claim 21, comprising at least two clamping cartridges, wherein corresponding pin pairs of the cartridges are aligned in the same plane.
